(19) United States
(12) Patent Application Publication
(10) Pub. No.: US 2004/0006619 A1
(43) Pub. Date: Jan. 8, 2004

(54) Structure for event reporting in SNMP systems

(75) Inventors: Sharfuddin Syed, Richardson, TX (US); Ted D. Chang, Richardson, TX (US); Guoliang Wu, Plano, TX (US); Robert Bryttegard, San Jose, CA (US)

Correspondence Address: BAKER BOTTS L.L.P., 2001 ROSS AVENUE, SUITE 600, DALLAS, TX, 75201-2980, US

(73) Assignee: Fujitsu Network Communications, Inc.

(21) Appl. No.: 10/189,131

(22) Filed: Jul. 2, 2002

(51) Int. Cl. G06F 15/173

(52) U.S. Cl. 709/224; 709/237

(57) ABSTRACT

In a system using simple network management protocol, elements report events to a network management system using a generic trap structure. The trap structure includes fields for identifying details on an object experiencing an event and detailing the event, and potentially includes management information for tracking individual trap messages.

### TECHNICAL FIELD OF THE INVENTION

The present invention relates generally to simple network management protocol (SNMP) systems and, more particularly, to structures for event reporting in SNMP systems.

### BACKGROUND OF THE INVENTION

Simple Network Management Protocol (SNMP) provides a mechanism for remote management of network devices, such as routers and bridges. SNMP supports device management using simple variables and standard techniques for specifying quantities recognized by devices. Moreover, SNMP provides a protocol for requesting, returning, and/or notifying of changes in values. In SNMP systems, devices can generate traps to report events. SNMP traps are assigned numerical values to indicate the particular type of event that occurred. For example, a trap indicating link failure may have a value of two. Thus, a network management system receiving such a trap from a device can display the type of event that occurred on the device based on the value of the received trap.

The types of traps used within a system may be customized by vendors or other entities to reflect the types of events monitored by system devices. For example, a particular vendor may establish several hundred enterprise-specific traps, with each trap assigned a numerical value. These traps allow devices to report any number of particular events that may occur.

### SUMMARY OF THE INVENTION

In accordance with the present invention, techniques for generation and use of structures for event reporting in SNMP systems are provided that substantially eliminate or reduce disadvantages or problems associated with previous techniques.

According to a particular embodiment, a method for reporting events detects an event in a simple network management protocol (SNMP) system, with the event affecting an object, and then generates a trap message that includes object information identifying the object and event information having multiple fields characterizing the event. The method communicates the trap message to a network management system. More specifically, the fields for event information may include an event type, a severity, a condition effect, a service effect, a location, and a direction, while the object information may include an object identifier and an object name.

Embodiments of the invention provide various technical advantages. The disclosed structures provide techniques for reporting detailed information regarding events occurring on managed devices. This permits faster and more effective response to events. For example, using the detailed information displayed from the variables indicated in the generic SNMP trap structure, an administrator can quickly identify an appropriate response and implement that response. In many situations, a generic trap message can convey virtually all information regarding the source and type of a problem. This can reduce the need for network management applications to poll for more detailed information, thus potentially decreasing the time for responding to the problem.

Moreover, these techniques provide a scaleable approach to SNMP trap reporting. That is, using a generic SNMP trap structure, the system easily supports the addition of any number of enterprise specific traps. Thus, these techniques are particularly applicable to modem systems in which a large number of traps, often numbering in the hundreds, are handled.

These techniques provide enhanced functionality and scalability while also reducing the amount of logic needed to handle exceptions. Because exceptions share a generic trap structure, separate logic for each exception may be unnecessary. This reduces memory usage in managed devices and potentially provides more robust software, since decreases in the amount of code used to generate logic typically increases the accuracy of the logic in use.

In addition to the other potential benefits, the disclosed techniques can be implemented in existing systems. For example, typical network management systems include display consoles that simply present the contents of received messages. Thus, many network management systems can process and present information from the generic trap structures without modifications to existing code. Therefore, increased functionality and decreased complexity can be provided without necessitating changes to management systems.

Other technical advantages of the present invention will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present invention and its advantages, reference is now made to the following description, taken in conjunction with the accompanying drawings, in which:

FIG. 1 illustrates a communication system having network elements that provide SNMP trap reporting according to various embodiments of the present invention;

FIG. 2 is a block diagram illustrating exemplary structure of a generic SNMP trap;

FIG. 3 is a block diagram illustrating exemplary functional components for a particular embodiment of a network element that reports events using a generic SNMP trap structure;

FIG. 4 is a flowchart illustrating a method for monitoring for and reporting events using a generic SNMP trap structure; and

FIG. 5 is a flowchart illustrating a method for processing SNMP trap messages received from managed devices.

### DETAILED DESCRIPTION OF THE DRAWINGS

FIG. 1 illustrates a communication system, indicated generally at 10, that includes network elements 12 operating within a network 14 that is managed by a network management system (NMS) 16. In general, network elements 12 provide autonomous messaging using a generic trap structure. More specifically, network elements 12 use a generic simple network management protocol (SNMP) trap structure to report events and provide information regarding these events to NMS 16.

Network elements 12 represent network devices, including hardware and any controlling logic, that support SNMP messaging. In the embodiment illustrated, network elements 12 interconnect to form a mesh of four network elements 12. However, while illustrated in a particular arrangement, system 10 contemplates including any number and type of network elements 12 arranged in any suitable configuration. Moreover, network elements 12 may include any appropriate network equipment, such as switches, routers, bridges, and other network devices supporting optical, electrical and other communications protocols. Thus, network 14 represents any suitable collection and arrangement of devices, including network elements 12, supporting transmission of information between communication devices.

NMS 16 manages some or all components of network 14, including network elements 12, using SNMP messaging. As a part of this management, NMS 16 receives SNMP messages from managed devices. To handle these messages, NMS 16 includes a display for presenting the information from the messages. These messages can include SNMP traps encoded using a generic trap structure. An administrator manning NMS 16 can use the information provided by received messages to appropriately respond to events within network 14. For example, through an interface of NMS 16, the administrator may generate messages to configure network elements 12 in response to various events autonomously reported in generic SNMP trap structures.

According to particular embodiments, NMS 16 is enhanced to recognize and automatically verify information in generic SNMP trap messages. For example, each trap message encoded within a generic SNMP trap structure may include a sequence number. NMS 16 can track these sequence numbers to detect when an “expected” trap was not received. NMS 16 can then request retransmission of trap messages from the particular network element 12 from which the message was expected. However, even if not enhanced to automatically respond to generic SNMP trap structures, administrators manning NMS 16 can monitor sequence numbers and other appropriate management information detailed in generic SNMP trap structures and respond appropriately.

During operation, network elements 12 generate messages reporting SNMP traps in response to any suitable event. For example, network elements 12 may generate SNMP trap messages to report faults, current status or conditions, provide notifications, or to report any other suitable event. To report SNMP traps to NMS 16, network elements 12 use a generic trap structure that provides relatively detailed information on the occurring event. According to particular embodiments, the generic trap message is assigned a single value, and trap types are differentiated by setting values within the trap structure. Thus, while all trap messages generated by network elements 12 that use the generic trap structure will be assigned the same value as structure, the contents of the trap structures will differentiate and provide far greater detail than traditional SNMP traps.

In the embodiment illustrated, one of network elements 12 has generated and communicated a trap message 18 to autonomously report an event to NMS 16. Trap 18 includes object information 20, event information 22, and management information 24. Object information 20 represents one or more variable values that identify the object that experienced the event resulting in trap 18. According to particular embodiments, object information 20 includes fields for an object identifier, an object name, and an entity type. The object identifier can, for example, indicate the SNMP Object ID assigned to the object using dotted notation, such as 1.3.6.1.4.1.3861.1.7.1.1.ifindex. The object name field includes a value that identifies the object using a more user-friendly format. According to particular embodiments, the object name field includes the translation language 1 (TL1) access identifier (AID) format of the object's name. For example, a TL1 AID of 1-1 can identify the element within slot 1, port 1 of a communications equipment rack. When presented to a user, the object name field may allow for easier identification of the object in comparison to the object identifier. The entity type field can include a value indicating the type of equipment generating the trap. For example, the entity type field may indicate whether the object is a port, a card, or other type of network equipment.

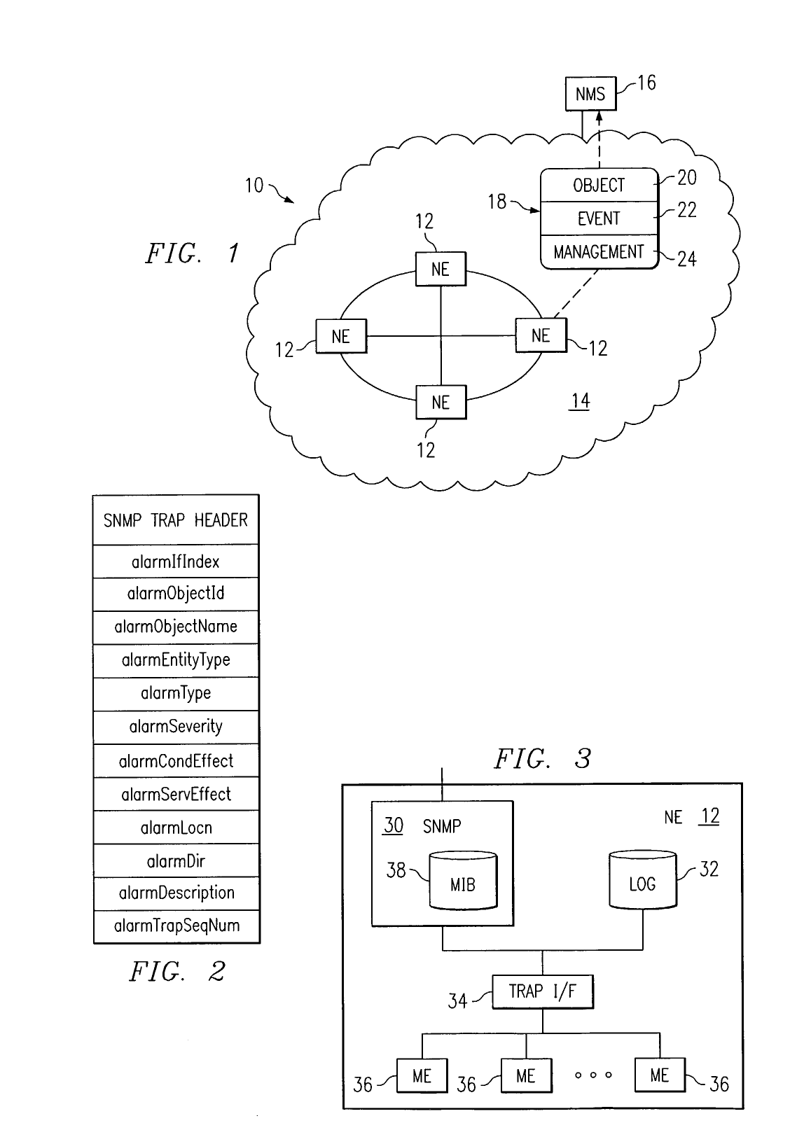

Event information 22 includes one or more fields describing the event that occurred to result in trap 18. According to particular embodiments, event information 22 includes fields for type, severity, condition effect, service effect, location, direction, and description. The type identifies the type of event that occurred. Thus, while the value of trap 18 as a whole may be equal to a value assigned to the generic trap structure, the value for the type field will identify the type of event that caused trap 18. The severity field indicates the criticality of the event using values such as minor, major, and critical. The condition effect characterizes the event as a standing or transient event. The service effect field characterizes the event as a service-affecting or non-service-affecting event. The location field indicates whether the event occurred at the near end or far end. The direction field indicates whether the event occurred in the receive or the transmit direction. The description field permits network element 12 to include a brief text description about the event that triggered trap 18. Thus, using the various fields provided within event information 22, network element 12 may identify particular characteristics of the event that caused a trap. Moreover, any number of variables within event information 22 may indicate information using various standards, such as the TELCORDIA standards. For example, the values for severity, condition effect, service effect, location, and direction may be defined based upon the TELCORDIA standards. For example, FIG. 2 illustrates an exemplary structure for trap 18.

Management information 24 includes one or more fields for managing the reporting of events using generic trap structures. For example, management information 24 may include a field for identifying a trap sequence number. According to particular embodiments, the trap sequence number is an integer value that is incremented for each trap generated by network element 12. This allows NMS 16 to track whether all traps from a particular network element 12 have been received and to identify particular traps that were not received.

However, while the preceding description focuses on particular fields that may be used to populate a generic trap structure, system 10 contemplates network elements 12 using any suitable combination and arrangement of variables within a generic trap structure, so long as those variables permit the identification of the event that occurred and the object to which the event occurred. Thus, the generic trap structure may include some or all of the exemplary variable fields identified and may include additional fields.

FIG. 3 is a block diagram illustrating exemplary modules of network element 12, which include an SNMP agent 30, an event log 32, a trap interface 34, and one or more managed elements 36. In general, trap interface 34 handles events of managed elements 36, providing information detailing these events for use by agent 30. Agent 30 generates SNMP trap messages, compiling the information from events into a generic trap structure to report traps to NMS 16.

Managed elements 36 represent any suitable network equipment within network element 12. For example, managed elements 36 may include cards, ports, and/or other suitable network equipment. Trap interface 34 and agent 30 represent functional modules that provide autonomous event reporting from network element 12 to NMS 16 using generic SNMP traps. In addition, agent 30 may support management and control of network element 12 in response to various SNMP messages. For example, in response to configuration and/or control messages received from NMS 16, agent 30 may configure and/or control various components, such as managed elements 36. Log 32 represents a database, maintained using any suitable storage devices and techniques, that maintains information detailing events detected by managed elements 36. For example, upon receiving event information from a particular managed element 36, trap interface 34 may generate an event entry within log 32 that identifies the managed element 36 and the particular event. Alternatively or in addition, agent 30 may generate event entries within log 32 or may supplement entries generated by trap interface 34. The information maintained for each event entry within log 32 includes any suitable data, such as object information 20, event information 22, and management information 24.

In operation, network element 12 provides network services using managed element 36. In response to any appropriate event, such as a fault or a change in status, managed element 36 reports information detailing the event to trap interface 34. In turn, trap interface 34 can report this information directly to agent 30 or generate an entry within log 32. Thus, depending upon the operation of trap interface 34, agent 30 may generate SNMP trap messages in response to direct communications from trap interface 34 and/or by monitoring log 32 for new event entries.

To generate a trap message, agent 30 populates a generic SNMP trap structure with information describing managed element 36, the event, and any appropriate management information. Agent 30 then communicates the trap to NMS 16. In response, NMS 16 can display the contents of the generic trap structure, thus allowing an administrator monitoring NMS 16 to appropriately respond to the event.

In addition to generating generic SNMP trap message autonomously, network element 12 may communicate generic SNMP trap messages in response to appropriate requests. For example, NMS 16 may request retransmission of some or all events maintained within log 32. In response, agent 30 accesses log 32 to obtain the information on the events for which retransmission was requested. For example, the request may identify particular sequence numbers or ranges of sequence numbers for retransmission. Agent 30 retrieves information from log 32 for events associated with the identified sequence numbers. Agent 30 then reports the requested information using any appropriate format. According to particular embodiments, agent 30 generates a generic SNMP trap structure for each requested event. Alternatively, agent 30 may use other formats that reduce the amount of information and/or combine information from multiple events to limit bandwidth usage during retransmissions of traps.

While the embodiment illustrated and the preceding description focus on a particular embodiment of network element 12 that includes specific modules, one of skill in the art will recognize that the functionalities and processes described may be achieved using any suitable combination and arrangement of elements. Moreover, some or all of the functionalities may be implemented using logic encoded in media, such as software, programmable logic devices, and/or other suitable encoded logic.

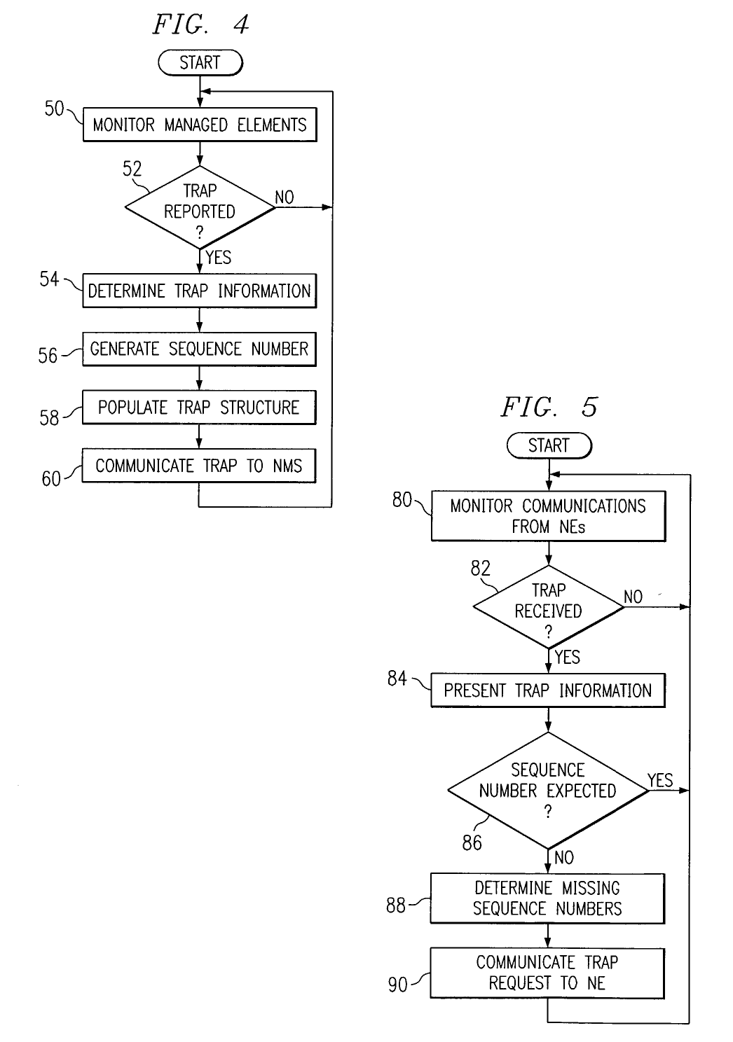

FIG. 4 is a flowchart illustrating the operation of network element 12 in autonomously reporting events to NMS 16 using a generic SNMP trap structure. Network element 12 monitors managed elements 36 at step 50. For example, trap interface 34 may monitor for reported events from managed elements 36. Similarly, agent 30 may monitor for reports from trap interface 34 and/or for new entries within log 32. Upon detecting a trap at step 52, network element 12 determines trap information at step 54. For example, in response to a reported trap by managed element 36, agent 30 may receive trap information identifying managed element 36 and the particular event from trap interface 34. Alternatively, agent 30 may detect a new event entry within log 32 and access this information. Agent 30 generates a sequence number for the trap at step 56. As previously discussed, this sequence number tracks the progression of events within network element 12. Agent 30 may associate the sequence number with the event entry within log 32 to permit future access based upon the sequence number. Using the trap information and sequence number, agent 30 populates the generic SNMP trap structure at step 58. For example, agent 30 may set values for object information 20, event information 22 and management information 24. Agent 30 then communicates the trap to NMS 16 at step 60.

The preceding flowchart illustrates an exemplary method for network element 12 to report events to NMS 16 using a generic SNMP trap structure. However, this flowchart illustrates only an exemplary method of operation, and network element 12 contemplates using any suitable techniques and elements for reporting events using a generic SNMP trap structure. Thus, many of the steps in this flowchart may take place simultaneously and/or in different orders than as shown. In addition, network element 12 may use methods with additional steps, fewer steps, and/or different steps, so long as the methods remain appropriate. For example, network element 12 may not use sequence numbers to identify specific traps communicated. Thus in these circumstances, network element 12 would not perform steps relating to sequence numbers.

FIG. 5 is a flowchart illustrating an exemplary method for NMS 16 to detect and request retransmission of unreceived trap messages. NMS 16 monitors communications from managed network elements 12 at step 80. Upon receiving a trap at step 82, NMS 16 presents the trap information at step 84. For example, using a display window, NMS 16 may present the values for each field within the received generic SNMP trap structure.

If appropriately enabled, NMS 16 may determine whether the sequence number in the received trap message was expected at step 86. For example, NMS 16 may determine whether the sequence number of the received trap message is the appropriate number given sequence numbers of previously received trap messages from network element 12. If the sequence number is not expected, NMS 16 determines the sequence numbers of missing SNMP trap messages from network element 12 at step 88. NMS 16 generates a request identifying the missing sequence numbers and communicates the trap request to network element 12 at step 90. This potentially results in NMS 16 receiving retransmissions of the requested traps from network element 12. NMS 16 may then handle these newly received retransmissions using techniques similar to those described above. For example, NMS 16 may display the contents of these retransmitted trap messages using a console, such that an administrator can track activities occurring on network elements 12.

The preceding flowchart illustrates only an exemplary method of operation, and NMS 16 contemplates using any suitable techniques and elements for processing generic SNMP traps and for detecting unreceived traps. Thus, many of the steps in this flowchart may take place simultaneously and/or in different orders than as shown. In addition, NMS 16 may use methods with additional steps, fewer steps, and/or different steps, so long as the methods remain appropriate.

Although the present invention has been described in several embodiments, a myriad of changes and modifications may be suggested to one skilled in the art, and it is intended that the present invention encompass such changes and modifications as fall within the scope of the present appended claims.

What is claimed is:

1. A method for reporting events, the method comprising:
detecting an event in a simple network management protocol (SNMP) system, the event affecting an object;
generating a trap message comprising object information identifying the object and event information comprising a plurality of fields characterizing the event; and
communicating the trap message to a network management system.

2. The method of claim 1, wherein the trap message further comprises management information that includes a sequence number for the trap message.

3. The method of claim 1, wherein the fields comprise an event type, a severity, a condition effect, a service effect, a location, and a direction.

4. The method of claim 1, wherein the object information comprises an object identifier and an object name.

5. The method of claim 4, wherein the object identifier indicates an SNMP object identifier assigned to the object and the object name indicates a translation language 1 (TL1) access identifier (AID) for the object.

6. The method of claim 1, wherein the object comprises a managed element within a network element, the method further comprising receiving the event information from the managed element.

7. The method of claim 1, further comprising storing the trap message in a memory.

8. The method of claim 7, further comprising:
receiving a request to retransmit the trap message;
retrieving the trap message from the memory; and
re-communicating the trap message to the network management system.

9. The method of claim 8, wherein the request to retransmit indicates a sequence number of the trap message.

10. A network element comprising:
a plurality of managed elements; and
a simple network management protocol (SNMP) agent operable to detect an event affecting one of the managed elements, to generate a trap message comprising object information identifying the affected managed element and event information comprising a plurality of fields characterizing the event, and to communicate the trap message to a network management system.

11. The network element of claim 10, wherein the trap message further comprises management information that includes a sequence number for the trap message.

12. The network element of claim 10, wherein the fields comprise an event type, a severity, a condition effect, a service effect, a location, and a direction.

13. The network element of claim 10, wherein the object information comprises an object identifier and an object name.

14. The network element of claim 13, wherein the object identifier indicates an SNMP object identifier assigned to the object and the object name indicates a translation language 1 (TL1) access identifier (AID) for the object.

15. The network element of claim 10, further comprising an event interface operable to receive the event information from the managed element and to relay the event information to the SNMP agent.

16. The network element of claim 10, further comprising a memory, wherein the SNMP agent is further operable to store the trap message in the memory.

17. The network element of claim 16, further comprising:
receiving a request to retransmit the trap message, the request indicating a sequence number of the trap message;
retrieving the trap message from the memory device using the sequence number; and
re-communicating the trap message to the network management system.

18. Logic for reporting events, the logic encoded in a medium and operable when executed to:
detect an event in a simple network management protocol (SNMP) system, the event affecting an object;
generate a trap message comprising object information identifying the object and event information comprising a plurality of fields characterizing the event; and
communicate the trap message to a network management system.

19. The logic of claim 18, wherein the trap message further comprises management information that includes a sequence number for the trap message.

20. The logic of claim 18, wherein the fields comprise an event type, a severity, a condition effect, a service effect, a location, and a direction.

21. The logic of claim 18, wherein the object information comprises an object identifier and an object name.

22. The logic of claim 21, wherein the object identifier indicates an SNMP object identifier assigned to the object and the object name indicates a translation language 1 (TL1) access identifier (AID) for the object.

23. The logic of claim 18, wherein the object comprises a managed element within a network element, the logic further operable to receive the event information from the managed element.

24. The logic of claim 18, further operable to:
store the trap message in a memory;
receive a request to retransmit the trap message, the request indicating a sequence number of the trap message;
retrieve the trap message from the memory device using the sequence number; and
re-communicate the trap message to the network management system.

25. A network element comprising:
means for detecting an event in a simple network management protocol (SNMP) system, the event affecting an object;
means for generating a trap message comprising object information identifying the object and event information comprising a plurality of fields characterizing the event; and
means for communicating the trap message to a network management system.

26. A method for reporting events, the method comprising:
detecting an event in a simple network management protocol (SNMP) system, the event affecting an object;
generating a trap message comprising object information, event information, and a sequence number, the object information comprising an object identifier indicating an SNMP object identifier assigned to the object and an object name indicating a translation language 1 (TL1) access identifier (AID) for the object, the event information comprising an event type, a severity, a condition effect, a service effect, a location, and a direction; and
communicating the trap message to a network management system.
